(19) United States
(12) Patent Application Publication
(10) Pub. No.: US 2026/0280740 A1
(43) Pub. Date: Sep. 17, 2026

(54) DELAY PROFILE BASED MODEL INPUT FOR AI/ML

(71) Applicant: Telefonaktiebolaget LM Ericsson (publ), Stockholm (SE)

(72) Inventors: Jung-Fu CHENG, Fremont, CA (US); Yufei BLANKENSHIP, Kildeer, IL (US)

(21) Appl. No.: 19/471,788

(22) PCT Filed: Apr. 5, 2024
(86) PCT No.: PCT/IB2024/053377

§ 371 Date: Oct. 2, 2025

Related U.S. Application Data
(60) Provisional application No. 63/457,975, filed on Apr. 7, 2023.

(51) Int. Cl. H04B 17/364; H04L 41/16

(52) U.S. Cl. CPC H04B 17/364; H04L 41/16

(57) ABSTRACT

Methods and systems are described for use of Delay Profile as an input for AI/ML models. The present disclosure includes solutions to only use DP as AI/ML model input, e.g. where the DP only contains the timing value of multiple received paths. In comparison to PDP, no received power values are needed as model input. Evaluation results demonstrate that AI/ML model performance is maintained with only small degradation when compared to PDP used as model input. Substantially reduced model input size gives significant advantage to AI/IL models under the present disclosure. For example, the measurement burden is reduced significantly. This benefit exists regardless of whether the measurements need to be signaled from one entity to another entity. Furthermore, when the measurements of model input need to be sent from one entity to another entity, the signaling overhead is significantly reduced.

### CROSS REFERENCE TO RELATED INFORMATION

This application claims the benefit of United States of America priority application No. 63/457,975 filed on Apr. 7, 2023, titled “Delay Profile Based Model Input for AI/ML.”

### TECHNICAL FIELD

The present disclosure generally relates to systems and methods for use of delay profile data as input for AI/ML models.

### BACKGROUND

### Overview of AI/ML for Wireless Communications

Artificial Intelligence (AI) and Machine Learning (ML) have been investigated as promising tools to optimize the design of air-interface in wireless communication networks in both academia and industry. Example use cases include using autoencoders for CSI (channel state information) compression to reduce the feedback overhead and improve channel prediction accuracy; using deep neural networks for classifying LOS (line of sight) and NLOS (non-line of sight) conditions to enhance the positioning accuracy; and using reinforcement learning (RL) for beam selection at the network side and/or the UE (user equipment) side to reduce the signaling overhead and beam alignment latency; using deep reinforcement learning to learn an optimal precoding policy for complex MIMO (multiple input multiple output) precoding problems.

In 3GPP NR standardization work, there will be a new release 18 study item on AI/ML for NR (New Radio) air interface starting in May 2022. This study item will explore the benefits of augmenting the air-interface with features enabling improved support of AI/ML based algorithms for enhanced performance and/or reduced complexity/overhead. Through studying a few selected use cases (CSI feedback, beam management and positioning), this SI (system information) aims at laying the foundation for future air-interface use cases leveraging AI/ML techniques.

Building an AI/ML model includes several development steps where the actual training of the AI model is just one step in a training pipeline. An important part in AI/MIL development is the AI/MIL model lifecycle management. This is illustrated in FIG. 1. FIG. 1 is an illustration of training and inference pipelines, and their interactions within a model lifecycle management procedure. The AI model lifecycle management typically comprises:
A training (re-training) pipeline: with data ingestion referring to gathering raw (training) data from a data storage. After data ingestion, there may also be a step that controls the validity of the gathered data; with data pre-processing referring to some feature engineering applied to the gathered data, e.g., it may include data normalization and possibly a data transformation required for the input data to the AI/MLI model; with the actual model training steps as previously outlined; with model evaluation referring to benchmarking the performance to some baseline. The iterative steps of model training and model evaluation continues until the acceptable level of performance (as previously exemplified) is achieved; with model registration referring to register the AI/ML model, including any corresponding AI/ML-meta data that provides information on how the AI/ME model was developed, and possibly AI/ML model evaluations performance outcomes.
A deployment stage to make the trained (or re-trained) AI/ML model part of the inference pipeline.
An inference pipeline: with data ingestion referring to gathering raw (inference) data from a data storage; with data pre-processing stage that is typically identical to corresponding processing that occurs in the training pipeline; with model operational referring to using the trained and deployed model in an operational mode; with data & model monitoring referring to validate that the inference data are from a distribution that aligns well with the training data, as well as monitoring model outputs for detecting any performance, or operational, drifts.
A drift detection stage that informs about any drifts in the model operations.

In a first scenario, one can assume that AI/ML models operating with the existing standard air-interface are placed at the UE side. A UE uses the AI/MIL models to generate output that is reported to a centralized node in the network for positioning the UE location.

In a second scenario, one can assume AI/IL models operating with the existing standard air-interface are placed at different Transmit/Receive Points (TRPs). A TRP uses the AI/MIL models to generate output that is reported to a centralized node in the network for positioning the UE location.

### AI/ML for Positioning

One AI/ML use case is the positioning of a target UE. The following cases are under investigation.
Case 1: UE-based positioning with UE-side model, direct AI/ML or AI/ML assisted positioning;
Case 2a: UE-assisted/LMF-based positioning with UE-side model, AI/ML assisted positioning;
Case 2b: UE-assisted/LMF (Location Management Function)-based positioning with LMF-side model, direct AI/ML positioning;
Case 3a: NG-RAN node assisted positioning with gNB-side model, AI/ML assisted positioning;
Case 3b: NG-RAN node assisted positioning with LMF-side model, direct AI/ML, positioning.

Most companies in 3GPP have used time domain channel impulse responses (CIR) or power delay profiles (PDP) on a regular sampling grid as input to the AI/ML, models. The CIRs and PDPs are typically truncated after a certain number of taps suitable for the specific sampling rates used and the intended uses cases. If the TRPs are equipped with multiple RX (reception) antenna ports, the CIR and PDP may take on additional dimensions. This is exemplified in the following agreement in 3GPP RAN1:

### Agreement

For the model input used in evaluations of AI/ML based positioning, if time-domain channel impulse response (CIR) or power delay profile (PDP) is used as model input in the evaluation, companies report the input dimension N_{TRP}*Nₚₒᵣₜ*Nₜ, where N_{TRP} is the number of TRPs, Nₚₒᵣₜ is the number of transmit/receive antenna port pairs, Nₜ is the number of time domain samples.
Note: CIR and PDP may have different dimensions.
Note: Companies provide details on their assumption on how PDP is constructed and how (if applicable) it is mapped to Nt samples.

In addition to the above agreement, it should be noted that the time domain CIRs are represented by complex values since both the I and Q branches are needed. Hence, a CIR sample requires N_{TRP}*Nₚₒᵣₜ*Nₜ*2*B_{CIR,real} bits, where B_{CIR,real} is the number bits for a real value

There currently exist certain challenges. In existing AI/ML models for positioning, the model input is either CIR or power delay profile (PDP). Use of CIR and PDP cause the model input to have a large size (e.g., large vector or large matrix). In consequence, it is a heavy demand to obtain measurements of CIR and PDP. When CIR or PDP measurements as model input need to be sent from one entity to another entity, the signaling overhead is also large.

### SUMMARY

One embodiment under the present disclosure comprises a method performed by a UE for using DP as an AI or ML model input. The method comprises receiving one or more delay profile data for a training phase; pre-processing the one or more delay profile data for the training phase; and training an AI or ML model with the pre-processed one or more delay profile data.

Another embodiment under the present disclosure is a method performed by a UE for using DP as an AI or ML model input. The method comprises receiving one or more DP data for an inference phase; pre-processing the one or more DP data for the inference phase; and using the pre-processed one or more DP data as one or more inputs for an AI or ML model.

Another embodiment under the present disclosure is a method performed by a UE for providing DP as an AI or ML model input. The method comprises receiving one or more radio signals from one or more radio nodes; generating one or more delay profile data based at least in part on the one or more radio signals; and transmitting the one or more delay profile data to a network node.

Another embodiment under the present disclosure is a method performed by a network node for using DP as an AI or ML model input. The method comprises receiving one or more delay profile data; pre-processing the one or more delay profile data; transmitting the preprocessed one or more delay profile data to a UE for use as one or more inputs to the AI or ML models; and receiving one or more outputs of the AI or ML models from the UE.

Another embodiment under the present disclosure is a method performed by a network node for using DP as an AI or ML model input. The method comprises receiving one or more delay profile data; pre-processing the one or more delay profile data; using the pre-processed one or more delay profile data as one or more inputs for the AI or ML model; and obtaining one or more outputs of the AI or ML models.

Another embodiment under the present disclosure comprises a method performed by a first network node for providing DP as an AI or ML model input. The method comprises receiving one or more radio signals from one or more radio nodes; generating one or more delay profile data based at least in part on the one or more radio signals; and transmitting the one or more delay profile data to a second network node for use in one or more inputs of an AI or ML model.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### BRIEF DESCRIPTION OF THE DRAWINGS

For a more complete understanding of the present disclosure, reference is now made to the following descriptions taken in conjunction with the accompanying drawings, in which:

FIG. 1 illustrates training and inference pipelines, and their interactions within a model lifecycle management procedure;

FIG. 2 illustrates an example of PDP;

FIG. 3 illustrates a complete PDP for a line-of-sight channel;

FIG. 4 illustrates a complete PDP for a non-line-of-sight channel;

FIG. 5 illustrates a DP;

FIG. 6 illustrates an example of reporting RSTD and additional paths' timing information by the UE;

FIG. 7 illustrates a table of model input size reduction from using timing information only per path, as compared to using both timing and power information per path;

FIG. 8 illustrates savings in percentage as a function of n, where n is the total number of paths;

FIG. 9 illustrates savings in percentage as a function of n, where n is the total number of paths;

FIG. 10 illustrates an example of AI/ML direct positioning where a LMF acts as the centralized node and process DPs corresponding to a multitude of TRPs to produce an estimate of the target UE's location;

FIG. 11 illustrates an example of AI/ML assisted positioning where a gNB acts as the centralized node and process DPs corresponding to a multitude of TRPs to produce estimates for unobserved direct path ToAs;

FIG. 12 illustrates an example of General AI/ML assisted positioning where multiple nodes processing DPs corresponding to a multitude of TRPs to produce estimates for unobserved direct path ToAs;

FIG. 13 illustrates an example 3GPP indoor factory (InF) model with 18 TRPs deployed at locations known at the network;

FIG. 14 illustrates a table of UE 2D positioning errors [in meters] at different percentiles;

FIG. 15 illustrates a flow-chart of a method embodiment under the present disclosure;

FIG. 16 illustrates a flow-chart of a method embodiment under the present disclosure;

FIG. 17 illustrates a flow-chart of a method embodiment under the present disclosure;

FIG. 18 illustrates a flow-chart of a method embodiment under the present disclosure;

FIG. 19 illustrates a flow-chart of a method embodiment under the present disclosure;

FIG. 20 illustrates a flow-chart of a method embodiment under the present disclosure;

FIG. 21 shows a schematic of a communication system embodiment under the present disclosure;

FIG. 22 shows a schematic of a user equipment embodiment under the present disclosure;

FIG. 23 shows a schematic of a network node embodiment under the present disclosure;

FIG. 24 shows a schematic of a host embodiment under the present disclosure;

FIG. 25 shows a schematic of a virtualization environment embodiment under the present disclosure; and

FIG. 26 shows a schematic representation of an embodiment of communication amongst nodes, hosts, and user equipment under the present disclosure.

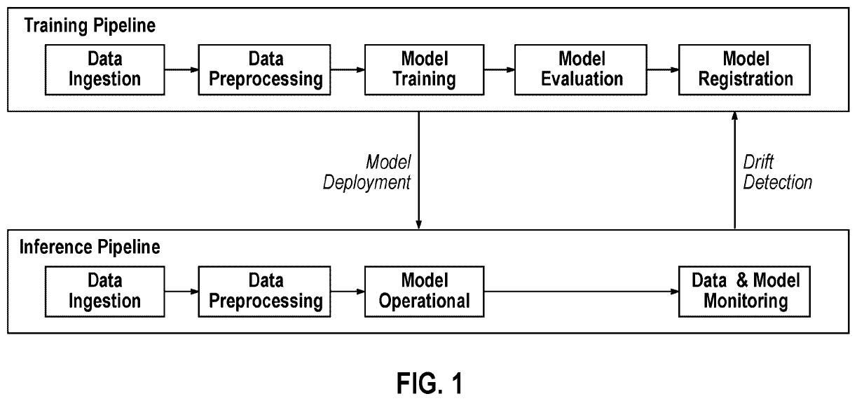

### DETAILED DESCRIPTION

Before describing various embodiments of the present disclosure in detail, it is to be understood that this disclosure is not limited to the parameters of the particularly exemplified systems, methods, apparatus, products, processes, and/or kits, which may, of course, vary. Thus, while certain embodiments of the present disclosure will be described in detail, with reference to specific configurations, parameters, components, elements, etc., the descriptions are illustrative and are not to be construed as limiting the scope of the claimed embodiments. In addition, the terminology used herein is for the purpose of describing the embodiments and is not necessarily intended to limit the scope of the claimed embodiments. Some of the embodiments contemplated herein will now be described more fully with reference to the accompanying drawings. Embodiments are provided by way of example to convey the scope of the subject matter to those skilled in the art.

In some embodiments a general term “network node” is used and it can correspond to any type of radio network node or any network node, which communicates with a UE and/or with another network node. Examples of network nodes are NodeB, eNodeB, gNodeB (or gNB), gNB-DU, gNB-CU, MeNB, SeNB, a network node belonging to MCG or SCG, base station (BS), multi-standard radio (MSR) radio node such as MSR BS, network controller, radio network controller (RNC), base station controller (BSC), relay, D2D UE to network relay, donor node controlling relay, base transceiver station (BTS), access point (AP), transmission points (TP), transmission and reception points (TRP), transmission nodes, RRU, RRH, nodes in distributed antenna system (DAS), core network node (e.g. MSC, MME etc), O&M, OSS, SON, positioning node (e.g. E-SMLC), location server, location management entity (LMF), MDT etc. In some embodiments the non-limiting terms UE or a wireless device are used interchangeably. The UE herein can be any type of wireless device capable of communicating with a network node or another UE over radio signals. The UE may also be a radio communication device, target device, device to device (D2D) UE, machine type UE or UE capable of machine to machine communication (M2M), low-cost and/or low-complexity UE, a sensor equipped with UE, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device etc.

As described above, there currently exist certain challenges in the prior art—use of CIR and PDP cause the model input to have a large size (e.g., large vector or large matrix). In consequence, it is a heavy demand to obtain measurements of CIR and PDP. When CIR or PDP measurements as model input need to be sent from one entity to another entity, the signaling overhead is also large.

Certain aspects of the disclosure and their embodiments may provide solutions to these or other challenges. The present disclosure includes solutions to use delay profile (DP) only as AI/ML, model input, e.g. where the DP only contains the timing value of the multiple received paths. In comparison to PDP, no received power values are needed as model input. Evaluation results demonstrate that the AI/ML model performance is maintained with only small degradation. Other embodiments include various encoding and storage methods to reduce dataset sizes.

Substantially reduced model input size gives significant advantage to the AI/ML model. For example, the measurement burden is reduced significantly. This benefit exists regardless of whether the measurements need to be signaled from one entity to another entity. Furthermore, when the measurements of model input need to be sent from one entity to another entity, the signaling overhead is significantly reduced.

Certain embodiments may provide one or more of the following technical advantages. Certain disclosed embodiments give significant advantage to the AI/ML model, due to the substantially reduced model input size. Advantages include that the measurement burden is reduced significantly. This benefit exists regardless of whether the measurements need to be signaled from one entity to another entity. Another advantage is that when the measurements of model input need to be sent from one entity to another entity, the signaling overhead is significantly reduced. Such signaling includes at least:
For the training data collection stage, the signaling for sending the measurements of model input from the measurement entity to the training data collection entity, if these two entities are different.
For the model inference stage, the signaling for the measurements of model input from the measurement entity to the model inference entity, if these two entities are different.
For the model monitoring stage, the signaling for the measurements of model input from the measurement entity to the model monitoring entity, if these two entities are different and the model monitoring method requires the observation of model input.
   Another advantage is that for training data collection, the substantially reduced model input size has reduced memory size for storing the measurements of model input. Also, for model training, since the number of features in model input is reduced by half when using DP instead of PDP, a smaller model can be obtained, which permits more efficient hardware implementation. In addition, for model monitoring, halving the number of features in model input make it easier to analyze model input distribution and generate model monitoring metrics.

Methods on using DP as AI/ML model input are described in the following. To have concrete signaling analysis and performance evaluation, the use case of AI/ML based positioning is used. While this is a typical use case of AI/ML, for wireless communication, this is a non-limiting example and is used to illustrate the methodology only. It is to be understood by those skilled in the art that the same methodologies and design principles can be extended to many other use cases, where DP is a useful feature to include in the AI/ML model input.

It is also noted that the disclosed methodologies and design principles can be applied to AI/ML model deployed in various entities in the wireless communications network, including, but not limited to, e.g.: a UE, network node, gNB, DU (distributed unit), RU (radio unit), LMF (Location and Management Function), and others.

### DP Model Input

In existing methods, two types of model input are often used as AI/ML model input: CIR and PDP. CIR provides rich information, but the model input size is very large. As a smaller size alternative, PDP can be used instead of CIR. When PDP is used for one pair of TRP−UE, for the time window containing a total of N sample and n received paths, two values are measured and reported for each of the n received paths:
The arrival time of the i-th path, {t₀, t₁, t₂, . . . , t₍ₙ₋₁₎} and
The power of the i-th path, {P₀, P₁, P₂, . . . , P₍ₙ₋₁₎}, i=0, 1, . . . , n−1.

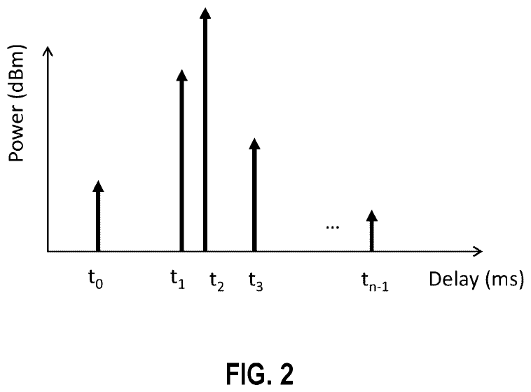

The PDP is illustrated in FIG. 2. Since both timing and power measurements need to be measured, the PDP tends to be a large set of information, although it's more compact than CIR.

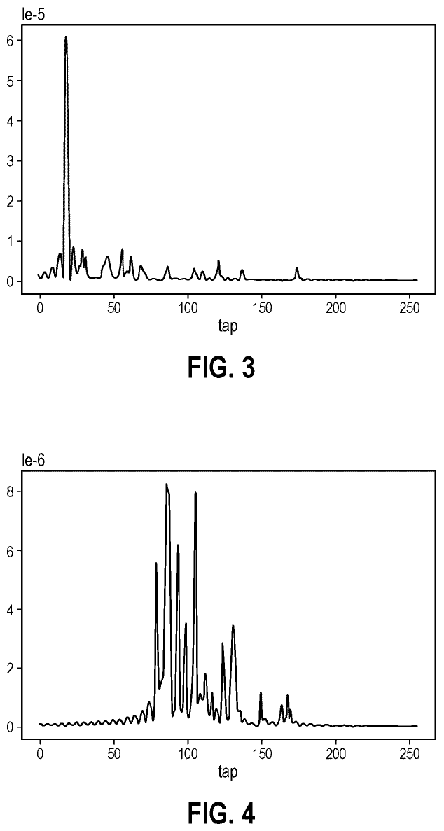

Considering the typical radio propagation environments, one can expect the strong CIR or PDP taps to exhibit clustered locations. FIG. 3 is an illustration of complete PDP for a line-of-sight channel. FIG. 4 is an illustration of complete PDP for a non-line-of-sight channel. In the line-of-sight channel example shown in FIG. 3, one can observe the strong taps to cluster around tap #20. Even for the non-line-of-sight channel example shown in FIG. 4, one can also observe the strong taps to concentrate in two clusters. Using such radio knowledge, a second exemplary embodiment is to encode the locations of nonzero taps using run-length coding.

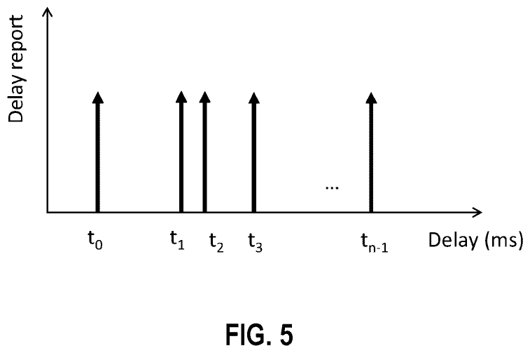

To reduce the size of information for describing the observed paths, according to certain embodiments of the present disclosure, just the DP can be used as AI/ML model inputs to achieve high performance. That is, the power aspect of each path can be ignored, and only the timing information of each paths is kept: t₀, t₁, t₂, . . . ,t₍ₙ₋₁₎). It also can be viewed as a simplified version of PDP where the power is set to a known fixed value (e.g., 1) always, i.e., no information is provided for the power aspect. This is illustrated in FIG. 5 which shows an example of DP, which can be compared to the down-sampled PDP illustrated in FIG. 2. It should be noted that DP can be described in various formats as described below.

In one method (direct indication approach), the arrival time of the n paths are provided via n timing values, {t₀, t₁, t₂, . . . ,t₍ₙ₋₁₎.}, t₀<t₁<t₍ₙ₋₁₎. In general, the timing values can be indicated by floating point values or fixed-point values. If the timing information needs to be signaled over an interface, the timing values are typically quantized into integer values, where the value range [tₘᵢₙ,tₘₐₓ] and resolution (i.e., quantization step size) are defined for the mapping between a floating point value and an integer value.

In one variant, a reference time t_{ref} (seconds) is provided in absolute value, while other timing values are provided as relative values tᵢ-t_{ref}. The absolute value and relative value can be indicated in floating point values or fixed-point values. If the timing information needs to be signaled over an interface, the absolute value and relative values are typically quantized into integer values. If the arrival time of one path is taken as the reference time, for example, the first path, t_{ref}=t₀, then there is no need to send the relative timing values for the reference path, e.g., t₀. In this case, the timing values are provided by (a) absolute value the reference time t_{ref}=t₀, and (b) relative timing values tᵢ-t_{ref}, i=1, 2, . . . n−1.

In another method (bitmap encoding approach), a measurement time window T (seconds) and a sampling period T_s (seconds) is defined, such that there are a total of N samples in the time window, N=T/Tₛ. A binary vector (i.e., bitmap) of length N is then used to provide arrival time of the paths, where at samples corresponding to {t₀, t₁, t₂, . . . ,t₍ₙ₋₁₎}, the vector elements have value ‘1’, while the vector elements have value ‘0’ for the other N−n samples. The sample index corresponding to path arrival time tᵢ can be calculated as:

$$round ( \frac{{t}_{i}}{{T}_{s}} ) .$$

In yet another method (reference time plus bitmap approach), a reference time t_{ref} (seconds) is directly indicated, together with a bitmap which provides the path timing values. The time window for the bitmap is from t_{ref} to t_{ref}+T. There are a total of N samples in the time window, N=T/Tₛ, where a sampling period Tₛ (seconds) is defined for the bitmap. A binary vector (i.e., bitmap) of length N is composed to provide arrival time of the paths, relative to t_{ref}, where at samples corresponding to {t₀, t₁, t₂, . . . ,t₍ₙ₋₁₎}, the vector elements have value ‘1’, while the vector elements have value ‘0’ for the other N-n samples. The sample index corresponding to path arrival time tᵢ can be calculated as:

$$round ( \frac{{t}_{i} - {t}_{ref}}{{T}_{s}} ) .$$

In one variant, the arrival time of one path is taken as the reference time, for example, the first path, t_{ref}=t₀. In this case, the bitmap does not need to include a bit for the reference path, e.g., t₀.

There are several further embodiments of using DP as input to an AI/ML model, including Embodiments A-D, discussed further below. Embodiment A uses a delay profile of a first detected path and additional paths. Embodiment B uses a delay profile of n strongest paths. Embodiment C uses a delay profile together with a signal quality indicator. Embodiment D uses a delay profile together with a small set of per-path indicators. These embodiments are given as examples and are not limiting of the teachings disclosed herein.

### Embodiment A: DP of First Detected Path and Additional Paths

In this embodiment, the delay profile includes the first detected path regardless of the strength of the first detected path, i.e., to always marks the arrival time of the first detected path. The rest of the delay profile {t₁, t₂, . . . ,t₍ₙ₋₁₎} provides information on the (n−1) additional paths that come after the first detected path. Typically, the (n−1) additional paths are selected such that the strongest paths are represented, e.g., the (n−1) paths with the highest received path power that come after the first detected path.

For the uplink, UL Relative Time of Arrival (T_{UL-RTOA}) (for the first path) and its relative delays are the NG-RAN (Next Generation Radio Access Network) measurement for path delays {t₀, t₁, t₂, . . . ,t₍ₙ₋₁₎}. For performing measurement of T_{UL-RTOA}, The UL Relative Time of Arrival (T_{UL-RTOA}) is the beginning of subframe i containing SRS (Sounding Reference Signal) received in Reception Point (RP) j, relative to the RTOA Reference Time.

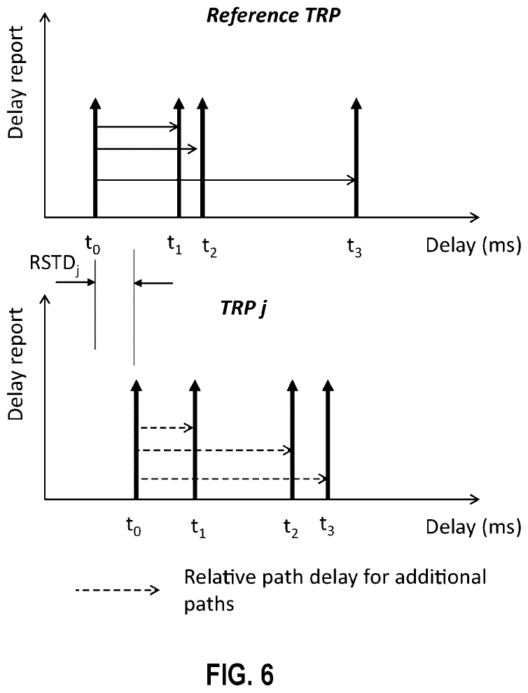

For the downlink, the timing information for the n paths may be provided in several manners. In one example, DL reference signal time difference (DL RSTD) is obtained for the reference path, where RSTD provides the relative timing difference between a j-th neighbour TRP and the PRS (Positioning Reference Signal) reference TRP. Furthermore, additional detected path timing values for the TRP or PRS resource are provided, which are relative to the path timing used for determining the RSTD value. This is illustrated in FIG. 6, which is an illustration of reporting RSTD and additional paths' timing information by the UE. In another example, UE Rx−Tx time difference (UE−RxTxTimeDiff) is obtained for the reference path. The UE Rx−Tx time difference is defined as T_{UE-RX}−T_{UE-RX}, where: T_{UE-RX} is the UE received timing of downlink subframe #i from a Transmission Point (TP), defined by the first detected path in time; T_{UE-TX} is the UE transmit timing of uplink subframe #j that is closest in time to the subframe #i received from the TP. Furthermore, additional detected path timing values for the TRP or PRS resource are provided, which are relative to the path timing used for determining the UE-RxTxTimeDiff value.

### Embodiment B: DP of n Strongest Paths

In this embodiment, the delay profile represents n strongest paths. For example, in the time window T, the n paths with the highest received path powers are selected. In this case, the first detected path may or may not be included, depending on whether the received power of the first path belongs to the n highest. On the other hand, this embodiment is the same as Embodiment A if the first path in the measurement report is simply considered the first detected path. That is, no additional effort is invested to search for the first detectable path; the first detected path is found the same way as the other paths, e.g., by checking the highest set of path powers.

### Embodiment C: DP with a Signal Quality Indicator

In this embodiment, the DP and a signal quality indicator are used in a combination for AI/ML model input. That is, DP provides timing information per path, while the signal quality indicator provides the overall received signal quality (i.e., not per path). Examples of signal quality indicator include the Received Signal Strength Indicator (RSSI) (e.g., the UE measurement of RSSI of OFDM symbols carrying the PRS resource). Another example is Reference signal received power (RSRP), which includes DL PRS reference signal received power (DL PRS-RSRP) and UL SRS reference signal received power (UL SRS-RSRP). Another example is Reference Signal Received Quality (RSRQ), which is a ratio between RSRP and RSSI.

### Embodiment D: DP with a Small Set of Per-Path Indicators

In this embodiment, the delay profile and a small set of per path indicators are provided as AI/ML model input. For example, a delay profile for n detected paths, together with m received path power (RSRPP) are used as model input, m<n. For instance, a delay profile of n=16 timing values together with m=2 RSRPP values are used. The m=2 RSRPP values may be provided for the two most representative paths, for example: (1) the first detected path and the path with the highest received power; (2) the two paths with the highest received path power.

### Analysis of Model Input Size Reduction

Using only DP as a model input has great advantages, as compared to using PDP or CIR. The advantages are due to, at least two factors. One is substantially reduced number of features at model input. For a given number of paths (n), DP-only uses n features (i.e., n path timings), PDP uses 2×n features (i.e., n path timings, and n power values), CIR uses 3×n features (i.e., n path timings, 2×n values for CIR since CIR values are complex). Another is substantially reduced model input size in terms of bits. In the following, the model input size reduction (in bits) from using DP instead of PDP is analyzed, using a positioning use case as an example. In some examples, the analysis also includes CIR.

### Model Input Analysis Based on New Signaling Format

When CIR is used, the channel impulse response of Nt time domain samples are used as input, and the CIR size (in number of bits) for one pair of TRP−UE has size Nₚₒᵣₜ*Nₜ*B_{CIR}, where B_{CIR} is the number of bits needed to represent one complex value for CIR at a sample time. The CIR value at a sample time should be represented by two floating point values, either {real, imaginary} or {magnitude, phase}. Thus, B_{CIR}=2*B_{CIR,real} where B_{CIR,real} is the number of bits needed for representing one real value for CIR. When CIR associated with NTRP TRPs are taken as model input, the total size of the CIR input is multiplied by N_{TRP}, i.e., N_{TRP}*Nₚₒᵣₜ*Nₜ* 2*B_{CIRreal} (bits). CIR input is expected to cause the model input size to be very large.

As an alternative, PDP can be used instead of CIR to reduce the model input size. While it is agreed in 3GPP that the PDP inputs to AI/ML, models are of dimension N_{TRP}* Nₚₒᵣₜ* Nₜ, further improvement can be used. Here N_{TRP} is the number of TRPs, Nₚₒᵣₜ is the number of transmit/receive antenna port pairs, Nₜ is the number of time domain samples. For a TRP equipped with multiple RX antenna ports, there is in fact no need to keep the port dimension for the PDP. This is because the actual PDP of the channel is identical for all RX ports. Instead, according to one embodiment, the PDP should be averaged over all RX ports as an additional averaging over fast fading. This average over RX ports results in a more correct dimension of N_{TRP}*1*Nₜ. Note also PDP is represented by real values. If a power value is represented by B_{PDP} bits, then the total size of PDP at the model input is: N_{TRP}*1*Nₜ*B_{PDP} (bits).

In summary, without down sampling, to store Nₛₐₘₚₗₑₛ of the CIR or PDP samples in a training dataset, the dataset will occupy:
For CIR: Nₛₐₘₚₗₑₛ*N_{TRP}*Nₚₒᵣₜ*Nₜ*2*B_{CIR,real} (bits)
For PDP: Nₛₐₘₚₗₑₛ*N_{TRP}*1*Nₜ*B_{PDP} (bits)

To further reduce the size of the dataset, down sampling the time domain taps can be considered. In one exemplary embodiment, the down sampling is performed to reduce the number of active (nonzero) time domain taps while keeping as much radio environment information as possible. As a nonlimiting embodiment, the number of active nonzero time domain taps are down select from the Nₜ taps by keeping only the Nₜ′ taps with stronger powers than the rest of the taps. For the CIR, such tap down selection is determined by averaging the power over RX ports. This down sampling (or sub-sampling) procedure attempts to keep the most salient channel information only, while discarding the weak, noisy information.

To store such sub-sampled time domain taps, efficient representations are needed for minimizing the dataset sizes. In one exemplary embodiment, such sub-sampled CIR or PDP is to store each sample in two pieces of information: a length-Nₜ bitmap representing the locations of the nonzero taps for a TRP link; and the values of the nonzero taps. Thus, with down sampling, to store Nₛₐₘₚₗₑₛ of the down sampled CIR samples, the dataset will use: Nₛₐₘₚₗₑₛ*N_{TRP}*Nₜ bits for the bitmaps, and Nₛₐₘₚₗₑₛ*N_{TRP}*Nₚₒᵣₜ*N_{t′}*2*B_{CIR,real} bits for values at the nonzero taps. This gives the total number of bits for CIR as:

$$= {N}_{samples} * {N}_{TRP} * {N}_{t} + {N}_{samples} * {N}_{TRP} * {N}_{port} * {N}_{t}^{′} * 2 * {B}_{CIR , real}$$

$$= {N}_{samples} * {N}_{TRP} * ( {N}_{t} + {N}_{t}^{′} * 2 * {B}_{CIR , real} )$$

Similarly, with down sampling, to store Nₛₐₘₚₗₑₛ of the down sampled PDP samples, the dataset will use:
Nₛₐₘₚₗₑₛ*N_{TRP}*Nₜ bits for the bitmaps, and
Nₛₐₘₚₗₑₛ*N_{TRP}*1*N_{t′}*B_{PDP} bits for power values at the nonzero taps.

This gives the total number of bits for PDP:

$$= {N}_{samples} * {N}_{TRP} * {N}_{t} + {N}_{s a m ples} * {N}_{TRP} * 1 * {N}_{t}^{′} * {B}_{PDP}$$

$$= {N}_{samples} * {N}_{TRP} * ( {N}_{t} + {N}_{t}^{′} * {B}_{PDP} )$$

Similarly, using the bitmap encoding approach, to store Nₛₐₘₚₗₑₛ of the down sampled DP samples, the dataset will use a total number of bits for DP: Nₛₐₘₚₗₑₛ*N_{TRP}*Nₜ bits for the bitmaps. This is a substantial reduction when compared with the size of CIR or PDP inputs.

To make a rough comparison amongst the three types of model inputs, the following specific values are used as an example for high resolution training datasets:

| | | |
|---|---|---|
| N_{TRP} = 18 | Nₚₒᵣₜ = 2 | Nₜ = 256 |
| Nₜ′ = 32 | B_{CIR, real} = B_{PDP} = 32 (bits) | Nₛₐₘₚₗₑₛ = 40,000 |

The resulting dataset sizes are:
2.949 GB for full 256-tap CIR inputs
737.3 MB for full 256-tap PDP inputs
391.7 MB for 32-tap CIR inputs
115.2 MB for 32-tap PDP inputs
23.04 MB for 32-tap DP inputs

In the example above, it is assumed that the time domain taps (or paths) are indicated via bitmaps. The bitmap for timing indication is acceptable if the timing window T for the paths are short. Otherwise, large timing window T implies a long bitmap, which is costly for signalling. In the example above, it is also assumed that the number of bits needed to represent a real value is the same regardless of CIR or PDP (i.e., B_{CIR,real}=B_{PDP}). Implementation limitations are not considered, for example, the achievable timing detection accuracy for a wideband reference signal vs a narrowband reference signal.

### Model Input Analysis Based on Existing Signaling Format

In the following section, analysis is provided for another format for representing the PDP and DP values as model input. Here the timing of the received paths are provided by: (a) absolute value of a reference time, and (b) relative values of additional paths.

The analysis assumes that measurement report for the model input need to be signalled from the measurement entity (e.g., UE or NG-RAN) to the model inference entity (e.g., LMF) via a standardized interface (e.g., LPP or NRPPa). Thus the number of bits needed to signal one measured model input value is specified. Downlink and uplink scenarios are considered.

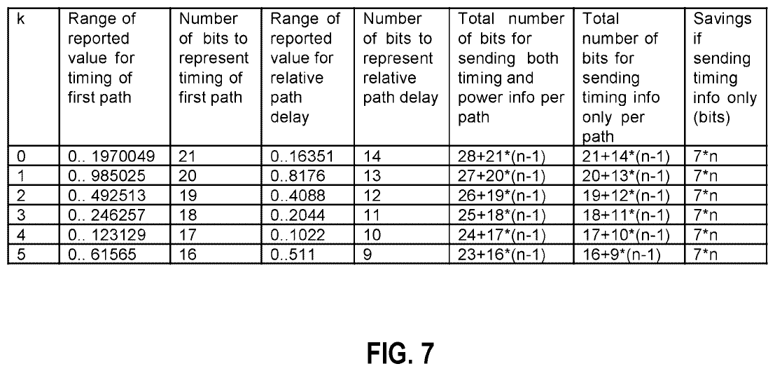

For positioning, in the downlink, the UE performs measurement on the PRS from one or more TRP. For the firth path, measurements include:
First path timing information, which can be DL-RSTD or UE-RxTxTimeDiff. The Range of reported value for the first path timing information is a function of integer k, see the second and third columns in FIG. 7.
First path power information, i.e., DL PRS-RSRPP of first path. Up to Rel-17, the range of reported value for PRS-RSRPP is 0 . . . 126, which is the same as that of PRS-RSRP. Thus 7 bits are needed to report the measurements of DL PRS-RSRPP.

For the (n−1) additional paths, the measurements include:
Per-path timing information, which is relative path delay, thus having a smaller value range for reporting. The range of reported value for additional path timing information is a function of integer k, see the fourth and fifth columns in FIG. 7.
Per-path power information, i.e., DL PRS-RSRPP for each of the additional paths. Similar to above, 7 bits are needed to report the measurements of DL PRS-RSRPP.

For positioning, in the uplink, NR-RAN performs measurement on the SRS, which is transmitted by the target UE. For the first path, measurements include:
First path timing information, which is UL RTOA. The range of reported value for the first path timing information is a function of integer k, see the second and third columns in FIG. 7.
First path power information, i.e., UL SRS-RSRPP of first path. Up to Rel-17, the range of reported value for SRS-RSRPP is 0 . . . 126, which is the same as that of SRS-RSRP. Thus 7 bits are needed to report the measurements of UL SRS-RSRPP.

For the (n−1) additional paths, measurements include:
Per-path timing information, which is a relative path delay, thus having a smaller value range for reporting. The range of reported value for additional path timing information is a function of integer k, see the second and third columns in FIG. 7.
Per-path power information, i.e., UL SRS-RSRPP for each of the additional paths. Similar to above, 7 bits are needed to report the measurements of UL SRS-RSRPP.

Since the number of bits for reporting the timing and power information are the same for DL and UL, the same table can be used to provide the model input size corresponding to the measurements. In FIG. 7, the model input size for using timing information only per path (i.e., DP) can be calculated, as compared to using both timing and power information per path (i.e., PDP). Note that in FIG. 7, the size calculation is for one pair of TRP-UE only. If N_{TRP} pairs are used for locating a target UE, then the full model input size for these measurements are N_{TRP} times as large. Similarly, when considering collecting Nₛₐₘₚₗₑₛ samples in a training dataset, the Nₛₐₘₚₗₑₛ multiplier needs to be applied too. The k value is an integer and it is configurable.

In FIG. 7, the value ranges specified in NR Rel-16/17 are reused. The range of timing value of first path is from −985024xT_{c} to 985024xT_{c} with the resolution step of 2^{k}xT_{c}. The range of relative path delay is from −8175xT_{c} to 8175xT_{c} with the resolution step of 2^{k}xT_{c}. The range of reported values are the integer values after quantization (i.e., mapping floating values to integer values). Here T_{c} is the basic timing unit used in NR, T_{c}=1/(Δfₘₐₓ·N_{f})=0.51 ns, where Δfₘₐₓ=480·10³ Hz and N_{f}=4096.

FIG. 7 displays model input size reduction from using timing information only per path, as compared to using both timing and power information per path. The total number of paths is n. The same calculation applies to both DL and UL. The size is calculated for one pair of TRP-UE only.

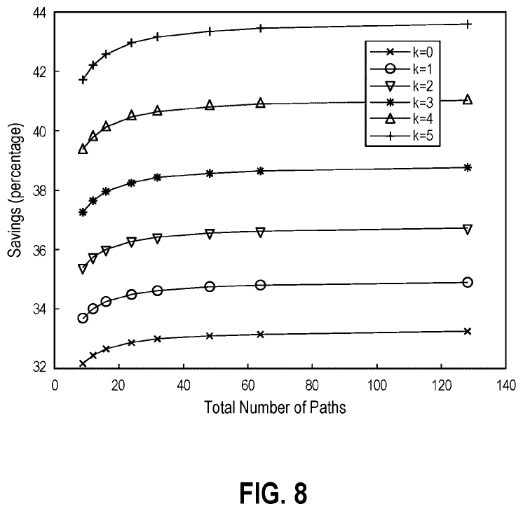

Corresponding to FIG. 7, FIG. 8 shows the savings in percentage as a function of n, where n is the total number of observed paths. It's shown that for n=9, the savings range from 32% to 42% for k=0 to 5; for n=128, the savings range from 33% to 43% for k=0 to 5. Overall, the range of savings is 32% to 43%. Rel-16/17 timing value ranges are assumed in FIG. 8.

The range of timing values used in FIG. 7 and FIG. 8 are very large, so that the largest cell radius (e.g., in rural areas) can be supported, for example, inter-site distance (ISD)=5000 m for a rural macro cell. However, the AI/ML model are designed for small cells, e.g., indoor office or indoor factory floor, where the typical ISD values are 20 m~50 m. Thus for AI/ML, models, the value range for the path timing can be greatly reduced.

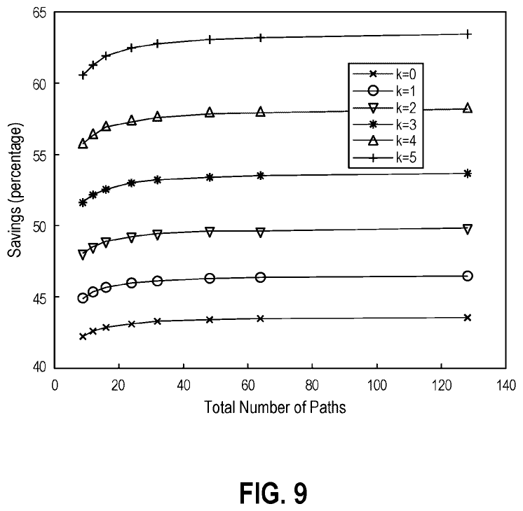

One example is shown as an illustration. The reduced range of timing value of first path is −7700xT_{c} to 7700xT_{c}, i.e., reduced by 128 times compared to Rel-16/17, thus saving 7 bits when reporting the absolute timing value for the first path. The reduced range of relative path delay is from −255xT_{c} to 255xT_{c}, i.e., reduced by 32 times compared to Rel-16/17, thus saving 5 bits when reporting the relative timing values for the additional path. When using the reduced value ranges, even more savings from using delay profile, instead of power delay profile, is achieved, as shown in FIG. 9. As can be observed in FIG. 9, the range of savings is 42% to 63%. FIG. 9 shows savings in percentage as a function of n, where n is the total number of paths. Timing value ranges reduced from Rel-16/17 are assumed, for AI/ML model deployed for smaller cell (including indoor factory cells).

Since AI/ML models are under development for smaller cells (e.g., indoor factory, urban canyon) where conventional positioning methods fail, this proves the benefits of using delay profile as input to the AI/ML model.

### AI/ML Model Impact on LCM Stages

In general, feature engineering is an important step to identify the most important features to include as model input, while excluding redundant, irrelevant, or unimportant information from model input. The goal is to keep the number of features at model input small without substantially sacrificing the model performance. This is exactly what's been achieved by using DP only rather than PDP or CIR.

Reduced number of features at model input has significant impact to model training, model structure, and model size. In general, smaller model input size leads to faster model training, since there are fewer features the model needs to learn. Small model input size also allows a simpler model structure and/or a smaller model size to be used. This then makes it easier to implement the model in hardware for model inference.

Reduced number of features for model input also makes it significantly easier to generate measurements, sending the measurement report (if needed), storing the measurement (e.g., for training data collection), and analyzing the measurements (e.g., for model monitoring).

Compared to PDP, for a given number of paths, DP has half as many features as PDP, i.e., path timing only vs both path timing and path power. Thus, if DP can be used in place of PDP as model input without significantly degrading model performance, it's a great advantage to use DP as model input. This has implications for every stage of AI/ML, model life cycle management (LCM) as shown in detail below.

Model training and generation: If using DP, simpler model structure and/or a smaller model size can be used, due to the significantly reduced number of features at model input. Faster model training is also achievable. This is particularly important if on-device training is desired.

Measurement for model input: It is simpler if only timing information of the received paths need to be measured, i.e., no need to measure per-path power. The measurement burden is thus reduced significantly when using DP only. This benefit exists regardless of whether the measurements need to be signaled from one entity to another entity.

Signaling of measurement report for model input: The signaling overhead for sending the measurement report for model input is significantly reduced if using DP instead of PDP. In addition, when the measurements of model input need to be sent from one entity to another entity, the signaling overhead is significantly reduced. Such signaling includes at least the following.
For all positioning cases 1/2a/2b/3a/3b: At the training data collection stage, the signaling for sending the measurements of model input from the measurement entity to the training data collection entity, if these two entities are different. At the model monitoring stage, the signaling for the measurements of model input from the measurement entity to the model monitoring entity, if these two entities are different and the model monitoring method requires the observation of model input statistics.
For positioning cases 2b and 3b: At the model inference stage, the signaling for the measurements of model input from the measurement entity (UE for case 2b, NG-RAN node for case 3b) to the model inference entity (IMF for case 2b/3b).

Note that, when considering the model inference stage, for Case 1/2a/3a, the measurements do not need to be sent from the measurement entity to another entity. However, for Case 2b and 3b, the entity to perform measurements for model input is different from the entity performing model inference. Thus the measurement reports for model input need to be sent from one entity to another entity for model inference.

Storage of collected training dataset: For training data collection, the substantially reduced number of features and model input size (in bits) also has the advantage of reduced memory size for storing the measurements of model input.

Model monitoring: For model monitoring methods that use statistical analysis of model input, reduced number of features at model input makes it simpler to analyze the model input data and generate model monitoring metrics. Additionally, the storage size for model inputs is also reduced, considering that model input values in a sliding observation window is typically stored for model monitoring purpose.

In summary, for positioning cases 1/2a/2b/3a/3c, the benefits model training and generation, measurements for model input, storage of collected training dataset, and model monitoring exist when the number of features at model input is reduced, as achieved by DP-only model input. For signaling of measurement report for model input, the benefit exists if the measurements need to be sent from one entity to another entity.

### Example Application to Positioning Cases

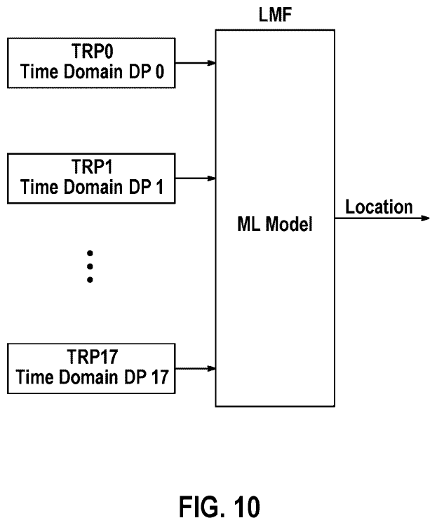

In a direct positioning AI/ML, model, the DPs corresponding to a multitude of TRPs are collected at a suitable centralized node (such as the LMF) to use as model inputs to estimate the UE locations. This is illustrated in FIG. 10. The DPs can be measured and signalled by the NG-RAN for the target UE, or the DPs can be measured and signalled by the target UE. FIG. 10 shows AI/ML, direct positioning where a LMF acts as the centralized node and process DPs corresponding to a multitude of TRPs to produce an estimate of the target UE's location.

If the model input is measurements of UL reference signal obtained by NG-RAN: At a i-th TRP, the delay profile for the {i-th TRP, target UE} pair can be determined from a UL signal (such as the sounding reference signal) transmitted by the target UE and received at the i-th TRP. The i-th TRP forwards or reports its DP measurement to the centralized node. Multiple TRPs send their measurement of the delay profile associated with the same target UE. Thus, the AI/ML, model at the centralized node can take DP from multiple TRPs as input, and determines the location of the target UE as a model output.

If the model input is measurements of DL reference signal obtained by the target UE: For a i-th TRP, the delay profile for the {i-th TRP, target UE} pair can be determined from a DL signal (such as the positioning reference signal) transmitted by the i-th TRP and received by the target UE. The UE reports its DP measurement associated with i-th TRP to the centralized node. After the UE has reported its DP measurements associated with multiple TRPs, the AI/ML model at the centralized node can take them as model input, and determines the location of the target UE as a model output.

In a centralized AI/ML assisted positioning model, the delay profiles corresponding to a multitude of transmit/receive points (TRPs) are collected at a suitable centralized node (such as the gNB or the LMF) to use as model inputs to estimate the direct path time of arrival (ToA) between said multitude of TRPs and the target UE. The estimated ToAs are forwarded to the LMF for determining the UE location.

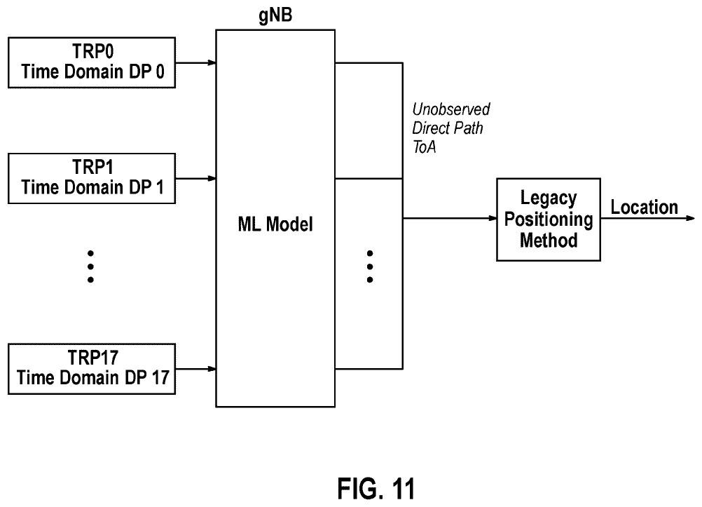

The delay profile for a i-th TRP can be determined from a UL signal (such as the sounding reference signal) transmitted by the target UE and received at the i-th TRP. The i-th TRP sends its DP measurements to the centralized node (e.g., the gNB associated with the i-th TRP). For a centralized node that are connected to multiple TRPs, each TRP can send its DP measurement to the central node associated with the given TRP. This allows the AI/ML model at the centralized node to take as input multiple DPs, each from a different TRP, and generates ToA estimation as model output. This is illustrated in FIG. 11. FIG. 11 shows AI/ML assisted positioning where a gNB acts as the centralized node and process DPs corresponding to a multitude of TRPs to produce estimates for unobserved direct path ToAs, which are further processed with conventional positioning algorithms to position of the target UE.

The delay profile for a i-th TRP can be determined from a DL signal (such as the positioning reference signal) transmitted by the i-th TRP and received by the target UE. The AI/ML model at the UE side takes the multiple DP measurements as model input, and estimate ToAs as model output.

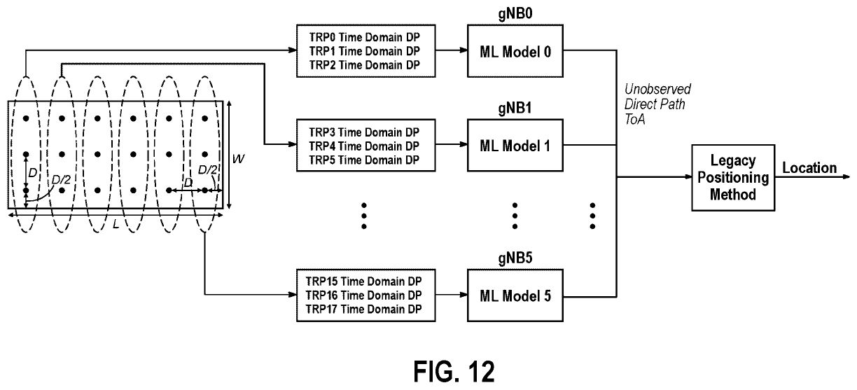

More generally, more than one node can process more than one DPs to produce direct path ToAs, which are then forwarded to the LMF for determining the UE location. This is illustrated in FIG. 12. FIG. 12 shows general AI/ML, assisted positioning where multiple nodes processing DPs corresponding to a multitude of TRPs to produce estimates for unobserved direct path ToAs, which are further processed with conventional positioning algorithms to determine the position of the target UE.

### Evaluation Results for Positioning Cases

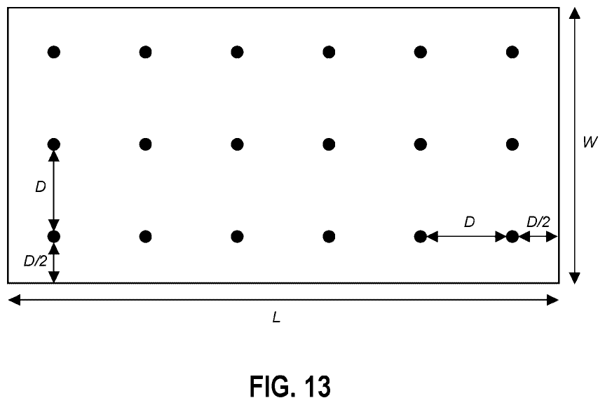

To proceed, a 3GPP indoor factory (InF) model illustrated in FIG. 13 is used as a nonlimiting example of a known deployment. In this scenario, 18 TRPs are deployed in the factory with TRP locations known at the network. With 60% clutter density and clutter height and width of 6 m and 2 m, respectively, this indoor factory scenario has less than 1% LoS probability from a UE to any TRPs.

For this example, a centralized ToA estimation model was used as illustrated in FIG. 11 for determining the UE locations. Two types of inputs were compared: PDP and DP. For PDP two cases were considered: complete PDP (with 256 taps) and the strongest 9-tap PDPs. For DP the number of taps considered were: 128, 64, 32, 16, and 9. The AI/ML models are trained with a dataset of Nₛₐₘₚₗₑₛ=20,000 PDP or DP samples. The trained models are then tested against a separate dataset of 4,000 PDP or DP samples.

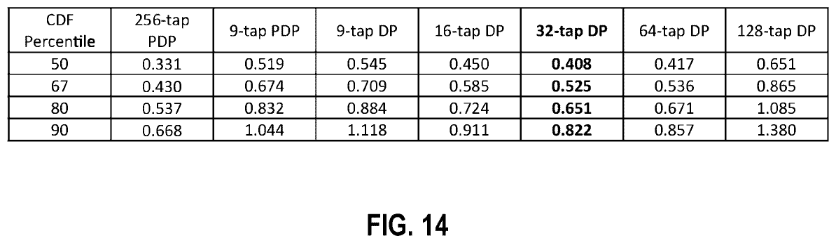

The 2D position errors at different percentiles are shown in FIG. 14. The following analysis use the 90 percentile 2D positioning error as the reference point for comparison. If the 90 percentile 2D positioning error is E, it means that the UE 2D positioning errors are smaller than E for 90% of the time. It can be expected that PDP inputs with more taps achieve better performance. Hence, the x-tap PDP performance is expected to locate between those for 256-tap and 9-tap PDP in the table below: 0.668 to 1.044 m. For DP only inputs, there is actually an optimal number of tap setting. This is to be expected. With too few taps, the DPs don't capture all useful information. With too many taps, useful information is compromised since both strong taps and tiny taps are represented by the same value: 1.

It can be observed that a 16-tap DP input is 10% better than a 9-tap PDP. In addition, the best performance is achieved with 32-tap DP inputs, which is 15 cm worse than 256-tap PDP but 22 cm better than 9-tap PDP.

### Additional Embodiments

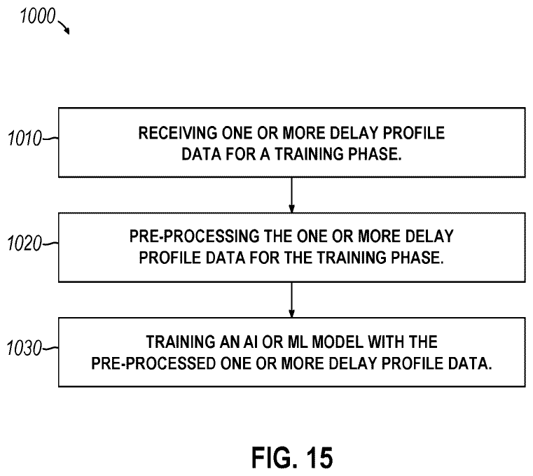

Another possible method embodiment under the present disclosure is shown in FIG. 15. Method 1000 comprises a method performed by a UE for using DP as an AI or ML model input. Step 1010 is receiving one or more delay profile data for a training phase. Step 1020 is pre-processing the one or more delay profile data for the training phase. Step 1030 is training an AI or ML model with the pre-processed one or more delay profile data. Method 1000 can comprise multiple variations and embodiments and/or additional and/or alternative steps.

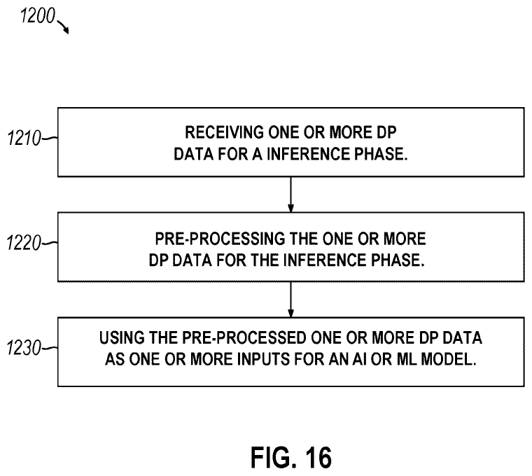

Another possible method embodiment under the present disclosure is shown in FIG. 16. Method 1200 comprises a method performed by a UE for using DP as an AI or ML model input. Step 1210 is receiving one or more DP data for an inference phase. Step 1220 is pre-processing the one or more DP data for the inference phase. Step 1230 is using the pre-processed one or more DP data as one or more inputs for an AI or ML model. Method 1200 can comprise multiple variations and embodiments and/or additional and/or alternative steps.

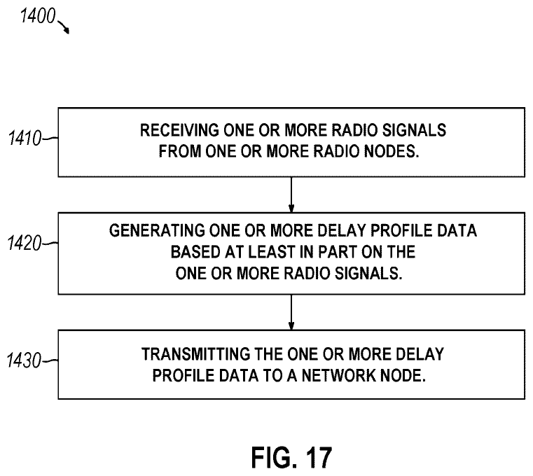

Another possible method embodiment under the present disclosure is shown in FIG. 17. Method 1400 comprises a method performed by a UE for providing DP as an AI or ML model input. Step 1410 is receiving one or more radio signals from one or more radio nodes. Step 1420 is generating one or more delay profile data based at least in part on the one or more radio signals. Step 1430 is transmitting the one or more delay profile data to a network node. Method 1400 can comprise multiple variations and embodiments and/or additional and/or alternative steps.

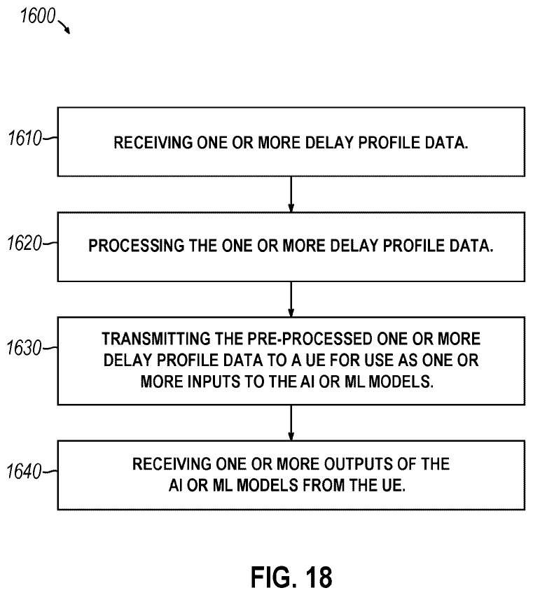

Another possible method embodiment under the present disclosure is shown in FIG. 18. Method 1600 comprises a method performed by a network node for using DP as an AI or ML model input. Step 1610 is receiving one or more delay profile data. Step 1620 is pre-processing the one or more delay profile data. Step 1630 is transmitting the preprocessed one or more delay profile data to a UE for use as one or more inputs to the AI or ML models. Step 1640 is receiving one or more outputs of the AI or ML models from the UE. Method 1600 can comprise multiple variations and embodiments and/or additional and/or alternative steps.

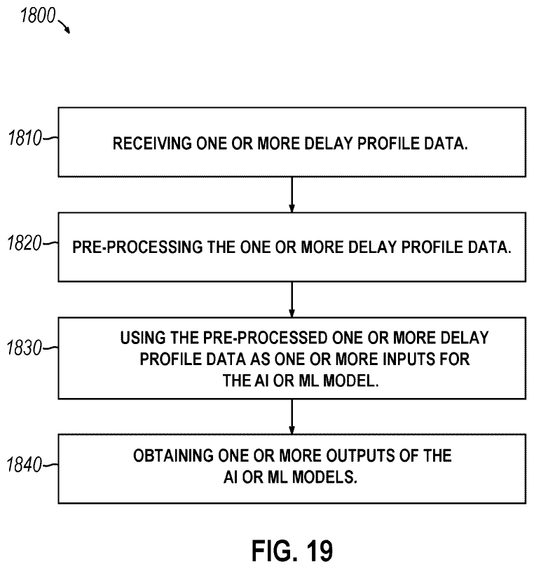

Another possible method embodiment under the present disclosure is shown in FIG. 19. Method 1800 comprises a method performed by a network node for using DP as an AI or ML model input. Step 1810 is receiving one or more delay profile data. Step 1820 is pre-processing the one or more delay profile data. Step 1830 is using the pre-processed one or more delay profile data as one or more inputs for the AI or ML model. Step 1840 is obtaining one or more outputs of the AI or ML models. Method 1800 can comprise multiple variations and embodiments and/or additional and/or alternative steps.

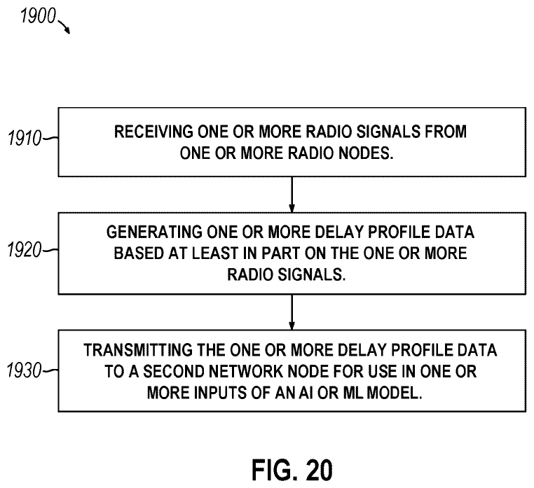

Another possible method embodiment under the present disclosure is shown in FIG. 20. Method 1900 comprises a method performed by a first network node for providing DP as an AI or ML model input. Step 1910 is receiving one or more radio signals from one or more radio nodes. Step 1920 is generating one or more delay profile data based at least in part on the one or more radio signals. Step 1930 is transmitting the one or more delay profile data to a second network node for use in one or more inputs of an AI or ML model. Method 1900 can comprise multiple variations and embodiments and/or additional and/or alternative steps.

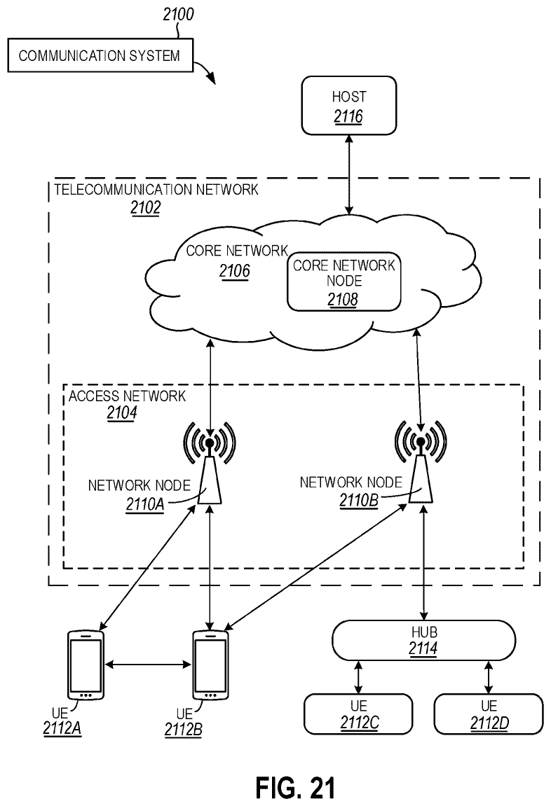

FIG. 21 shows an example of a communication system 2100 in accordance with some embodiments. In the example, the communication system 2100 includes a telecommunication network 2102 that includes an access network 2104, such as a RAN, and a core network 2106, which includes one or more core network nodes 2108. The access network 2104 includes one or more access network nodes, such as network nodes 2110a and 2110b (one or more of which may be generally referred to as network nodes 2110), or any other similar 3rd Generation Partnership Project (3GPP) access node or non-3GPP access point. The network nodes 2110 facilitate direct or indirect connection of UE, such as by connecting UEs 2112a, 2112b, 2112c, and 2112d (one or more of which may be generally referred to as UEs 2112) to the core network 2106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1100 may include any number of wired or wireless networks, network nodes, UEs, and/or any other components or systems that may facilitate or participate in the communication of data and/or signals whether via wired or wireless connections. The communication system 2100 may include and/or interface with any type of communication, telecommunication, data, cellular, radio network, and/or other similar type of system.

The UEs 2112 may be any of a wide variety of communication devices, including wireless devices arranged, configured, and/or operable to communicate wirelessly with the network nodes 2110 and other communication devices. Similarly, the network nodes 2110 are arranged, capable, configured, and/or operable to communicate directly or indirectly with the UEs 2112 and/or with other network nodes or equipment in the telecommunication network 2102 to enable and/or provide network access, such as wireless network access, and/or to perform other functions, such as administration in the telecommunication network 2102.

In the depicted example, the core network 2106 connects the network nodes 2110 to one or more hosts, such as host 2116. These connections may be direct or indirect via one or more intermediary networks or devices. In other examples, network nodes may be directly coupled to hosts. The core network 2106 includes one more core network nodes (e.g., core network node 2108) that are structured with hardware and software components. Features of these components may be substantially similar to those described with respect to the UEs, network nodes, and/or hosts, such that the descriptions thereof are generally applicable to the corresponding components of the core network node 2108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 2116 may be under the ownership or control of a service provider other than an operator or provider of the access network 2104 and/or the telecommunication network 2102, and may be operated by the service provider or on behalf of the service provider. The host 2116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 2100 of FIG. 21 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 2102 is a cellular network that implements 3GPP standardized features. Accordingly, the telecommunications network 2102 may support network slicing to provide different logical networks to different devices that are connected to the telecommunication network 2102. For example, the telecommunications network 2102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 2112 are configured to transmit and/or receive information without direct human interaction. For instance, a UE may be designed to transmit information to the access network 2104 on a predetermined schedule, when triggered by an internal or external event, or in response to requests from the access network 2104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example, the hub 2114 communicates with the access network 2104 to facilitate indirect communication between one or more UEs (e.g., UE 2112c and/or 2112d) and network nodes (e.g., network node 2110b). In some examples, the hub 2114 may be a controller, router, content source and analytics, or any of the other communication devices described herein regarding UEs. For example, the hub 2114 may be a broadband router enabling access to the core network 2106 for the UEs. As another example, the hub 2114 may be a controller that sends commands or instructions to one or more actuators in the UEs. Commands or instructions may be received from the UEs, network nodes 2110, or by executable code, script, process, or other instructions in the hub 2114. As another example, the hub 2114 may be a data collector that acts as temporary storage for UE data and, in some embodiments, may perform analysis or other processing of the data. As another example, the hub 2114 may be a content source. For example, for a UE that is a VR headset, display, loudspeaker or other media delivery device, the hub 2114 may retrieve VR assets, video, audio, or other media or data related to sensory information via a network node, which the hub 2114 then provides to the UE either directly, after performing local processing, and/or after adding additional local content. In still another example, the hub 2114 acts as a proxy server or orchestrator for the UEs, in particular in if one or more of the UEs are low energy IoT devices.

The hub 2114 may have a constant/persistent or intermittent connection to the network node 2110b. The hub 2114 may also allow for a different communication scheme and/or schedule between the hub 2114 and UEs (e.g., UE 2112c and/or 2112d), and between the hub 2114 and the core network 2106. In other examples, the hub 2114 is connected to the core network 2106 and/or one or more UEs via a wired connection. Moreover, the hub 2114 may be configured to connect to an M2M service provider over the access network 1104 and/or to another UE over a direct connection. In some scenarios, UEs may establish a wireless connection with the network nodes 2110 while still connected via the hub 2114 via a wired or wireless connection. In some embodiments, the hub 2114 may be a dedicated hub—that is, a hub whose primary function is to route communications to/from the UEs from/to the network node 2110b. In other embodiments, the hub 2114 may be a non-dedicated hub—that is, a device which is capable of operating to route communications between the UEs and network node 2110b, but which is additionally capable of operating as a communication start and/or end point for certain data channels.

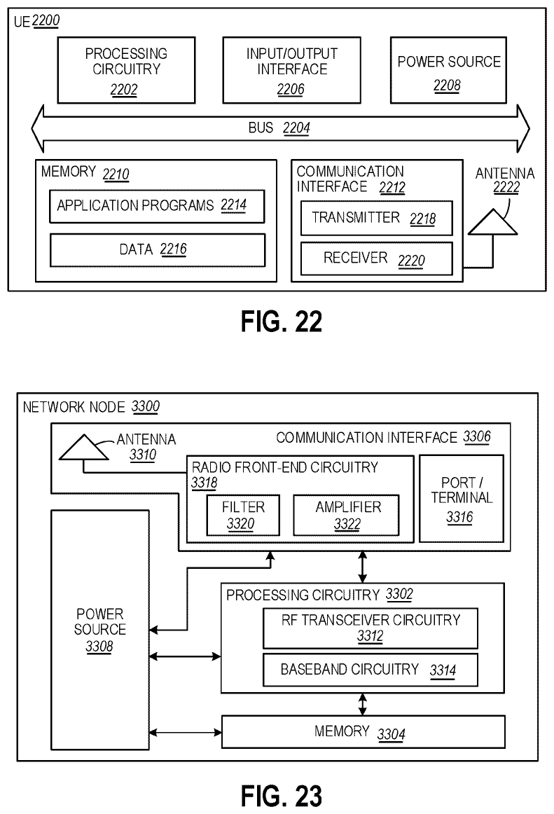

FIG. 22 shows a UE 2200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 2200 includes processing circuitry 2202 that is operatively coupled via a bus 2204 to an input/output interface 2206, a power source 2208, a memory 2210, a communication interface 2212, and/or any other component, or any combination thereof. Certain UEs may utilize all or a subset of the components shown in FIG. 10. The level of integration between the components may vary from one UE to another UE. Further, certain UEs may contain multiple instances of a component, such as multiple processors, memories, transceivers, transmitters, receivers, etc.

The processing circuitry 2202 is configured to process instructions and data and may be configured to implement any sequential state machine operative to execute instructions stored as machine-readable computer programs in the memory 2210. The processing circuitry 2202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 2202 may include multiple central processing units (CPUs).

In the example, the input/output interface 2206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 2200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 2208 is structured as a battery or battery pack. Other types of power sources, such as an external power source (e.g., an electricity outlet), photovoltaic device, or power cell, may be used. The power source 2208 may further include power circuitry for delivering power from the power source 2208 itself, and/or an external power source, to the various parts of the UE 2200 via input circuitry or an interface such as an electrical power cable. Delivering power may be, for example, for charging of the power source 2208. Power circuitry may perform any formatting, converting, or other modification to the power from the power source 2208 to make the power suitable for the respective components of the UE 2200 to which power is supplied.

The memory 2210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 2210 includes one or more application programs 2214, such as an operating system, web browser application, a widget, gadget engine, or other application, and corresponding data 2216. The memory 2210 may store, for use by the UE 2200, any of a variety of various operating systems or combinations of operating systems.

The memory 2210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DEVIM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 2210 may allow the UE 2200 to access instructions, application programs and the like, stored on transitory or non-transitory memory media, to off-load data, or to upload data. An article of manufacture, such as one utilizing a communication system may be tangibly embodied as or in the memory 2210, which may be or comprise a device-readable storage medium.

The processing circuitry 2202 may be configured to communicate with an access network or other network using the communication interface 2212. The communication interface 2212 may comprise one or more communication subsystems and may include or be communicatively coupled to an antenna 2222. The communication interface 2212 may include one or more transceivers used to communicate, such as by communicating with one or more remote transceivers of another device capable of wireless communication (e.g., another UE or a network node in an access network). Each transceiver may include a transmitter 2218 and/or a receiver 2220 appropriate to provide network communications (e.g., optical, electrical, frequency allocations, and so forth). Moreover, the transmitter 2218 and receiver 2220 may be coupled to one or more antennas (e.g., antenna 2222) and may share circuit components, software or firmware, or alternatively be implemented separately.

In the illustrated embodiment, communication functions of the communication interface 2212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 2212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 2200 shown in FIG. 22.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 23 shows a network node 3300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 3300 includes a processing circuitry 3302, a memory 3304, a communication interface 3306, and a power source 3308. The network node 3300 may be composed of multiple physically separate components (e.g., a NodeB component and a RNC component, or a BTS component and a BSC component, etc.), which may each have their own respective components. In certain scenarios in which the network node 3300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1300 may be configured to support multiple radio access technologies (RATs). In such embodiments, some components may be duplicated (e.g., separate memory 3304 for different RATs) and some components may be reused (e.g., a same antenna 3310 may be shared by different RATs). The network node 3300 may also include multiple sets of the various illustrated components for different wireless technologies integrated into network node 1300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1300.

The processing circuitry 3302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 3300 components, such as the memory 3304, to provide network node 3300 functionality.

In some embodiments, the processing circuitry 3302 includes a system on a chip (SOC). In some embodiments, the processing circuitry 3302 includes one or more of radio frequency (RF) transceiver circuitry 3312 and baseband processing circuitry 3314. In some embodiments, the radio frequency (RF) transceiver circuitry 3312 and the baseband processing circuitry 3314 may be on separate chips (or sets of chips), boards, or units, such as radio units and digital units. In alternative embodiments, part or all of RF transceiver circuitry 3312 and baseband processing circuitry 3314 may be on the same chip or set of chips, boards, or units.

The memory 3304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 3302. The memory 3304 may store any suitable instructions, data, or information, including a computer program, software, an application including one or more of logic, rules, code, tables, and/or other instructions capable of being executed by the processing circuitry 3302 and utilized by the network node 3300. The memory 3304 may be used to store any calculations made by the processing circuitry 3302 and/or any data received via the communication interface 3306. In some embodiments, the processing circuitry 3302 and memory 3304 is integrated.

The communication interface 3306 is used in wired or wireless communication of signaling and/or data between a network node, access network, and/or UE. As illustrated, the communication interface 3306 comprises port(s)/terminal(s) 3316 to send and receive data, for example to and from a network over a wired connection. The communication interface 3306 also includes radio front-end circuitry 3318 that may be coupled to, or in certain embodiments a part of, the antenna 3310. Radio front-end circuitry 3318 comprises filters 3320 and amplifiers 3322. The radio front-end circuitry 3318 may be connected to an antenna 3310 and processing circuitry 3302. The radio front-end circuitry may be configured to condition signals communicated between antenna 3310 and processing circuitry 3302. The radio front-end circuitry 3318 may receive digital data that is to be sent out to other network nodes or UEs via a wireless connection. The radio front-end circuitry 3318 may convert the digital data into a radio signal having the appropriate channel and bandwidth parameters using a combination of filters 3320 and/or amplifiers 3322. The radio signal may then be transmitted via the antenna 3310. Similarly, when receiving data, the antenna 3310 may collect radio signals which are then converted into digital data by the radio front-end circuitry 3318. The digital data may be passed to the processing circuitry 3302. In other embodiments, the communication interface may comprise different components and/or different combinations of components.

In certain alternative embodiments, the network node 3300 does not include separate radio front-end circuitry 3318, instead, the processing circuitry 3302 includes radio front-end circuitry and is connected to the antenna 3310. Similarly, in some embodiments, all or some of the RF transceiver circuitry 3312 is part of the communication interface 3306. In still other embodiments, the communication interface 3306 includes one or more ports or terminals 3316, the radio front-end circuitry 3318, and the RF transceiver circuitry 3312, as part of a radio unit (not shown), and the communication interface 3306 communicates with the baseband processing circuitry 3314, which is part of a digital unit (not shown).

The antenna 3310 may include one or more antennas, or antenna arrays, configured to send and/or receive wireless signals. The antenna 3310 may be coupled to the radio front-end circuitry 3318 and may be any type of antenna capable of transmitting and receiving data and/or signals wirelessly. In certain embodiments, the antenna 3310 is separate from the network node 3300 and connectable to the network node 3300 through an interface or port.

The antenna 3310, communication interface 3306, and/or the processing circuitry 3302 may be configured to perform any receiving operations and/or certain obtaining operations described herein as being performed by the network node. Any information, data and/or signals may be received from a UE, another network node and/or any other network equipment. Similarly, the antenna 3310, the communication interface 3306, and/or the processing circuitry 3302 may be configured to perform any transmitting operations described herein as being performed by the network node. Any information, data and/or signals may be transmitted to a UE, another network node and/or any other network equipment.

The power source 3308 provides power to the various components of network node 3300 in a form suitable for the respective components (e.g., at a voltage and current level needed for each respective component). The power source 3308 may further comprise, or be coupled to, power management circuitry to supply the components of the network node 3300 with power for performing the functionality described herein. For example, the network node 3300 may be connectable to an external power source (e.g., the power grid, an electricity outlet) via an input circuitry or interface such as an electrical cable, whereby the external power source supplies power to power circuitry of the power source 3308. As a further example, the power source 3308 may comprise a source of power in the form of a battery or battery pack which is connected to, or integrated in, power circuitry. The battery may provide backup power should the external power source fail.

Embodiments of the network node 3300 may include additional components beyond those shown in FIG. 23 for providing certain aspects of the network node's functionality, including any of the functionality described herein and/or any functionality necessary to support the subject matter described herein. For example, the network node 3300 may include user interface equipment to allow input of information into the network node 3300 and to allow output of information from the network node 3300. This may allow a user to perform diagnostic, maintenance, repair, and other administrative functions for the network node 3300.

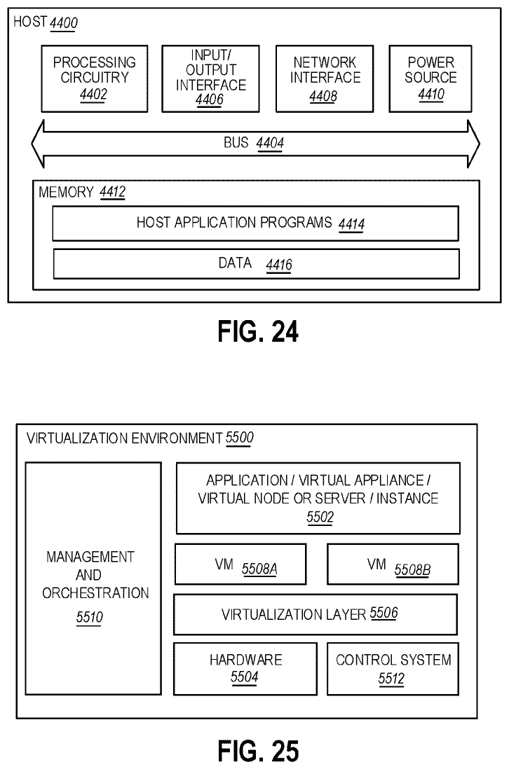

FIG. 24 is a block diagram of a host 4400, which may be an embodiment of the host 2116 of FIG. 21, in accordance with various aspects described herein. As used herein, the host 4400 may be or comprise various combinations hardware and/or software, including a standalone server, a blade server, a cloud-implemented server, a distributed server, a virtual machine, container, or processing resources in a server farm. The host 4400 may provide one or more services to one or more UEs.

The host 4400 includes processing circuitry 4402 that is operatively coupled via a bus 4404 to an input/output interface 4406, a network interface 4408, a power source 4410, and a memory 4412. Other components may be included in other embodiments. Features of these components may be substantially similar to those described with respect to the devices of previous figures, such as FIGS. 22 and 23, such that the descriptions thereof are generally applicable to the corresponding components of host 4400.

The memory 4412 may include one or more computer programs including one or more host application programs 4414 and data 4416, which may include user data, e.g., data generated by a UE for the host 4400 or data generated by the host 4400 for a UE. Embodiments of the host 4400 may utilize only a subset or all of the components shown. The host application programs 4414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 4414 may also provide for user authentication and licensing checks and may periodically report health, routes, and content availability to a central node, such as a device in or on the edge of a core network. Accordingly, the host 4400 may select and/or indicate a different host for over-the-top services for a UE. The host application programs 4414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 25 is a block diagram illustrating a virtualization environment 5500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 5500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 5502 (which may alternatively be called software instances, virtual appliances, network functions, virtual nodes, virtual network functions, etc.) are run in the virtualization environment 5500 to implement some of the features, functions, and/or benefits of some of the embodiments disclosed herein.

Hardware 5504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 5506 (also referred to as hypervisors or virtual machine monitors (VMMs)), provide VMs 5508a and 5508b (one or more of which may be generally referred to as VMs 5508), and/or perform any of the functions, features and/or benefits described in relation with some embodiments described herein. The virtualization layer 5506 may present a virtual operating platform that appears like networking hardware to the VMs 5508.

The VMs 5508 comprise virtual processing, virtual memory, virtual networking or interface and virtual storage, and may be run by a corresponding virtualization layer 5506. Different embodiments of the instance of a virtual appliance 5502 may be implemented on one or more of VMs 5508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 5508 may be a software implementation of a physical machine that runs programs as if they were executing on a physical, non-virtualized machine. Each of the VMs 5508, and that part of hardware 5504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 5508 on top of the hardware 5504 and corresponds to the application 5502.

Hardware 5504 may be implemented in a standalone network node with generic or specific components. Hardware 5504 may implement some functions via virtualization. Alternatively, hardware 5504 may be part of a larger cluster of hardware (e.g., such as in a data center or CPE) where many hardware nodes work together and are managed via management and orchestration 5510, which, among others, oversees lifecycle management of applications 5502. In some embodiments, hardware 5504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 5512 which may alternatively be used for communication between hardware nodes and radio units.

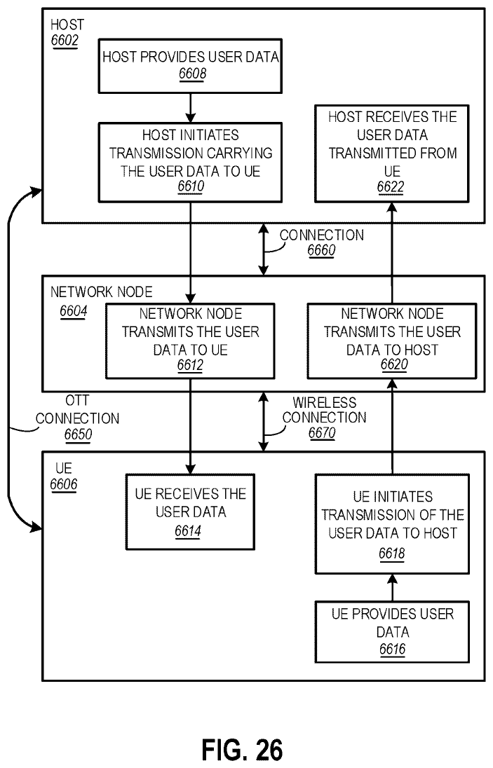

FIG. 26 shows a communication diagram of a host 6602 communicating via a network node 6604 with a UE 6606 over a partially wireless connection in accordance with some embodiments. Example implementations, in accordance with various embodiments, of the UE (such as a UE 2112a of FIG. 21 and/or UE 2200 of FIG. 22), network node (such as network node 2110a of FIG. 21 and/or network node 3300 of FIG. 23), and host (such as host 2116 of FIG. 21 and/or host 4400 of FIG. 24) discussed in the preceding paragraphs will now be described with reference to FIG. 26.

Like host 4400, embodiments of host 6602 include hardware, such as a communication interface, processing circuitry, and memory. The host 6602 also includes software, which is stored in or accessible by the host 6602 and executable by the processing circuitry. The software includes a host application that may be operable to provide a service to a remote user, such as the UE 6606 connecting via an over-the-top (OTT) connection 6650 extending between the UE 6606 and host 6602. In providing the service to the remote user, a host application may provide user data which is transmitted using the OTT connection 6650.

The network node 6604 includes hardware enabling it to communicate with the host 6602 and UE 6606. The connection 6660 may be direct or pass through a core network (like core network 2106 of FIG. 21) and/or one or more other intermediate networks, such as one or more public, private, or hosted networks. For example, an intermediate network may be a backbone network or the Internet.

The UE 6606 includes hardware and software, which is stored in or accessible by UE 6606 and executable by the UE's processing circuitry. The software includes a client application, such as a web browser or operator-specific “app” that may be operable to provide a service to a human or non-human user via UE 6606 with the support of the host 6602. In the host 6602, an executing host application may communicate with the executing client application via the OTT connection 6650 terminating at the UE 6606 and host 6602. In providing the service to the user, the UE's client application may receive request data from the host's host application and provide user data in response to the request data. The OTT connection 6650 may transfer both the request data and the user data. The UE's client application may interact with the user to generate the user data that it provides to the host application through the OTT connection 6650.

The OTT connection 6650 may extend via a connection 6660 between the host 6602 and the network node 6604 and via a wireless connection 6670 between the network node 6604 and the UE 6606 to provide the connection between the host 6602 and the UE 6606. The connection 6660 and wireless connection 6670, over which the OTT connection 6650 may be provided, have been drawn abstractly to illustrate the communication between the host 6602 and the UE 1606 via the network node 6604, without explicit reference to any intermediary devices and the precise routing of messages via these devices.

As an example of transmitting data via the OTT connection 6650, in step 6608, the host 6602 provides user data, which may be performed by executing a host application. In some embodiments, the user data is associated with a particular human user interacting with the UE 6606. In other embodiments, the user data is associated with a UE 6606 that shares data with the host 6602 without explicit human interaction. In step 6610, the host 6602 initiates a transmission carrying the user data towards the UE 6606. The host 6602 may initiate the transmission responsive to a request transmitted by the UE 6606. The request may be caused by human interaction with the UE 6606 or by operation of the client application executing on the UE 6606. The transmission may pass via the network node 6604, in accordance with the teachings of the embodiments described throughout this disclosure. Accordingly, in step 6612, the network node 6604 transmits to the UE 6606 the user data that was carried in the transmission that the host 6602 initiated, in accordance with the teachings of the embodiments described throughout this disclosure. In step 6614, the UE 6606 receives the user data carried in the transmission, which may be performed by a client application executed on the UE 6606 associated with the host application executed by the host 6602.

In some examples, the UE 6606 executes a client application which provides user data to the host 6602. The user data may be provided in reaction or response to the data received from the host 6602. Accordingly, in step 6616, the UE 6606 may provide user data, which may be performed by executing the client application. In providing the user data, the client application may further consider user input received from the user via an input/output interface of the UE 6606. Regardless of the specific manner in which the user data was provided, the UE 6606 initiates, in step 6618, transmission of the user data towards the host 6602 via the network node 6604. In step 6620, in accordance with the teachings of the embodiments described throughout this disclosure, the network node 6604 receives user data from the UE 6606 and initiates transmission of the received user data towards the host 6602. In step 6622, the host 6602 receives the user data carried in the transmission initiated by the UE 6606.

One or more of the various embodiments improve the performance of OTT services provided to the UE 6606 using the OTT connection 6650, in which the wireless connection 6670 forms the last segment. More precisely, the teachings of these embodiments may improve the data rate, latency, and/or power consumption and thereby provide benefits such as reduced user waiting time, relaxed restriction on file size, improved content resolution, better responsiveness, and/or extended battery lifetime.

In an example scenario, factory status information may be collected and analyzed by the host 6602. As another example, the host 6602 may process audio and video data which may have been retrieved from a UE for use in creating maps. As another example, the host 6602 may collect and analyze real-time data to assist in controlling vehicle congestion (e.g., controlling traffic lights). As another example, the host 6602 may store surveillance video uploaded by a UE. As another example, the host 6602 may store or control access to media content such as video, audio, VR or AR which it can broadcast, multicast or unicast to UEs. As other examples, the host 6602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 6650 between the host 6602 and UE 6606, in response to variations in the measurement results. The measurement procedure and/or the network functionality for reconfiguring the OTT connection may be implemented in software and hardware of the host 6602 and/or UE 6606. In some embodiments, sensors (not shown) may be deployed in or in association with other devices through which the OTT connection 6650 passes; the sensors may participate in the measurement procedure by supplying values of the monitored quantities exemplified above, or supplying values of other physical quantities from which software may compute or estimate the monitored quantities. The reconfiguring of the OTT connection 6650 may include message format, retransmission settings, preferred routing etc.; the reconfiguring need not directly alter the operation of the network node 6604. Such procedures and functionalities may be known and practiced in the art. In certain embodiments, measurements may involve proprietary UE signaling that facilitates measurements of throughput, propagation times, latency and the like, by the host 6602. The measurements may be implemented in that software causes messages to be transmitted, in particular empty or ‘dummy’ messages, using the OTT connection 6650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

It will be appreciated that computer systems are increasingly taking a wide variety of forms. In this description and in the claims, the terms “controller,” “computer system,” or “computing system” are defined broadly as including any device or system—or combination thereof—that includes at least one physical and tangible processor and a physical and tangible memory capable of having thereon computer-executable instructions that may be executed by a processor. By way of example, not limitation, the term “computer system” or “computing system,” as used herein is intended to include personal computers, desktop computers, laptop computers, tablets, hand-held devices (e.g., mobile telephones, PDAs, pagers), microprocessor-based or programmable consumer electronics, minicomputers, mainframe computers, multi-processor systems, network PCs, distributed computing systems, datacenters, message processors, routers, switches, and even devices that conventionally have not been considered a computing system, such as wearables (e.g., glasses).

The computing system also has thereon multiple structures often referred to as an “executable component.” For instance, the memory of a computing system can include an executable component. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed by one or more processors on the computing system, whether such an executable component exists in the heap of a computing system, or whether the executable component exists on computer-readable storage media. The structure of the executable component exists on a computer-readable medium in such a form that it is operable, when executed by one or more processors of the computing system, to cause the computing system to perform one or more functions, such as the functions and methods described herein. Such a structure may be computer-readable directly by a processor—as is the case if the executable component were binary. Alternatively, the structure may be structured to be interpretable and/or compiled—whether in a single stage or in multiple stages—so as to generate such binary that is directly interpretable by a processor.

The terms “component,” “service,” “engine,” “module,” “control,” “generator,” or the like may also be used in this description. As used in this description and in this case, these terms—whether expressed with or without a modifying clause—are also intended to be synonymous with the term “executable component” and thus also have a structure that is well understood by those of ordinary skill in the art of computing.

In terms of computer implementation, a computer is generally understood to comprise one or more processors or one or more controllers, and the terms computer, processor, and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

In general, the various exemplary embodiments may be implemented in hardware or special purpose chips, circuits, software, logic, or any combination thereof. For example, some aspects may be implemented in hardware, while other aspects may be implemented in firmware or software which may be executed by a controller, microprocessor, or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques, or methods described herein may be implemented in, as non-limiting examples, hardware, software, firmware, special purpose circuits or logic, general purpose hardware or controller or other computing devices, or some combination thereof.

While not all computing systems require a user interface, in some embodiments a computing system includes a user interface for use in communicating information from/to a user. The user interface may include output mechanisms as well as input mechanisms. The principles described herein are not limited to the precise output mechanisms or input mechanisms as such will depend on the nature of the device. However, output mechanisms might include, for instance, speakers, displays, tactile output, projections, holograms, and so forth. Examples of input mechanisms might include, for instance, microphones, touchscreens, projections, holograms, cameras, keyboards, stylus, mouse, or other pointer input, sensors of any type, and so forth.

### Abbreviations and Defined Terms

To assist in understanding the scope and content of this written description and the appended claims, a select few terms are defined directly below. Unless defined otherwise, all technical and scientific terms used herein have the same meaning as commonly understood by one of ordinary skill in the art to which the present disclosure pertains.

The terms “approximately,” “about,” and “substantially,” as used herein, represent an amount or condition close to the specific stated amount or condition that still performs a desired function or achieves a desired result. For example, the terms “approximately,” “about,” and “substantially” may refer to an amount or condition that deviates by less than 10%, or by less than 5%, or by less than 1%, or by less than 0.1%, or by less than 0.01% from a specifically stated amount or condition.

Various aspects of the present disclosure, including devices, systems, and methods may be illustrated with reference to one or more embodiments or implementations, which are exemplary in nature. As used herein, the term “exemplary” means “serving as an example, instance, or illustration,” and should not necessarily be construed as preferred or advantageous over other embodiments disclosed herein. In addition, reference to an “implementation” of the present disclosure or embodiments includes a specific reference to one or more embodiments thereof, and vice versa, and is intended to provide illustrative examples without limiting the scope of the present disclosure, which is indicated by the appended claims rather than by the present description.

As used in the specification, a word appearing in the singular encompasses its plural counterpart, and a word appearing in the plural encompasses its singular counterpart, unless implicitly or explicitly understood or stated otherwise. Thus, it will be noted that, as used in this specification and the appended claims, the singular forms “a,” “an” and “the” include plural referents unless the context clearly dictates otherwise. For example, reference to a singular referent (e.g., “a widget”) includes one, two, or more referents unless implicitly or explicitly understood or stated otherwise. Similarly, reference to a plurality of referents should be interpreted as comprising a single referent and/or a plurality of referents unless the content and/or context clearly dictate otherwise. For example, reference to referents in the plural form (e.g., “widgets”) does not necessarily require a plurality of such referents. Instead, it will be appreciated that independent of the inferred number of referents, one or more referents are contemplated herein unless stated otherwise.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### CONCLUSION

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

It is understood that for any given component or embodiment described herein, any of the possible candidates or alternatives listed for that component may generally be used individually or in combination with one another, unless implicitly or explicitly understood or stated otherwise. Additionally, it will be understood that any list of such candidates or alternatives is merely illustrative, not limiting, unless implicitly or explicitly understood or stated otherwise.

In addition, unless otherwise indicated, numbers expressing quantities, constituents, distances, or other measurements used in the specification and claims are to be understood as being modified by the term “about,” as that term is defined herein. Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the standard deviation found in their respective testing measurements.

Any headings and subheadings used herein are for organizational purposes only and are not meant to be used to limit the scope of the description or the claims. The terms and expressions which have been employed herein are used as terms of description and not of limitation, and there is no intention in the use of such terms and expressions of excluding any equivalents of the features shown and described or portions thereof, but it is recognized that various modifications are possible within the scope of the present disclosure. Thus, it should be understood that although the present disclosure has been specifically disclosed in part by certain embodiments, and optional features, modification and variation of the concepts herein disclosed may be resorted to by those skilled in the art, and such modifications and variations are considered to be within the scope of this present description.

It will also be appreciated that systems, devices, products, kits, methods, and/or processes, according to certain embodiments of the present disclosure may include, incorporate, or otherwise comprise properties or features (e.g., components, members, elements, parts, and/or portions) described in other embodiments disclosed and/or described herein. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

It will be apparent to one of ordinary skill in the art that methods, devices, device elements, materials, procedures, and techniques other than those specifically described herein can be applied to the practice of the described embodiments as broadly disclosed herein without resort to undue experimentation. All art-known functional equivalents of methods, devices, device elements, materials, procedures, and techniques specifically described herein are intended to be encompassed by this present disclosure.

When a group of materials, compositions, components, or compounds is disclosed herein, it is understood that all individual members of those groups and all subgroups thereof are disclosed separately. When a Markush group or other grouping is used herein, all individual members of the group and all combinations and sub-combinations possible of the group are intended to be individually included in the disclosure.

The above-described embodiments are examples only. Alterations, modifications, and variations may be effected to the particular embodiments by those of skill in the art without departing from the scope of the description, which is defined solely by the appended claims.

1. A method performed by a user equipment, UE, for using delay profile as an artificial intelligence, AI, or machine learning, ML, model input, the method comprising:
receiving one or more delay profile data for a training phase;
pre-processing the one or more delay profile data for the training phase; and
training an AI or ML model with the pre-processed one or more delay profile data.

2-5. (canceled)

6. The method of claim 1, further comprising:
receiving one or more delay profile data for an inference phase;
pre-processing the one or more delay profile data for the inference phase; and
using the pre-processed one or more delay profile data as one or more inputs for an AI or ML model.

7. The method of claim 6, further comprising updating the AI or ML model based at least in part on the one or more inputs.

8. The method of claim 1, further comprising obtaining an output of the AI or ML model.

9. The method of claim 8, further comprising reporting the output to a network node.

10-11. (canceled)

12. The method of claim 1, wherein the one or more delay profile data comprise only timing value data of multiple received paths.

13. The method of claim 12, wherein the multiple received paths are selected based on the strongest received path powers.

14. The method of claim 12, wherein the multiple received paths are selected based on the earliest received path timings

15. (canceled)

16. The method of claim 12, wherein the one or more delay profile data do not contain received power values for each of the multiple received paths.

17. The method of claim 12, wherein no power values for each of the multiple received paths comprise the one or more inputs.

18-19. (canceled)

20. The method of claim 1, further comprising measuring a radio signal, generating a power value from the radio signal, and transmitting the power value to the network node.

21. (canceled)

22. The method of claim 1, further comprising detecting one or more power delay profile data, and extracting the one or more delay profile data from the one or more power delay profile data.

23. A method performed by a network node for using delay profile as an artificial intelligence, AI, or machine learning, ML, model input, the method comprising:
receiving one or more delay profile data;
pre-processing the one or more delay profile data;
transmitting the preprocessed one or more delay profile data to a user equipment, UE, for use as one or more inputs to the AI or ML models; and
receiving one or more outputs of the AI or ML models from the UE.

24-26. (canceled)

27. The method of claim 23, wherein preprocessing comprises combining one or more signal power measurements and the one or more delay profile data.

28-30. (canceled)

31. The method of claim 23, wherein at least one of the one or more outputs is related to a position of the UE.

32. The method of claim 23, wherein only the one or more delay profile data are used as the one or more inputs.

33. The method of claim 23, wherein the one or more delay profile data comprise only timing value data of multiple received paths.

34. The method of claim 23, further comprising transmitting the one or more outputs to another network node.

35-36. (canceled)

37. A user equipment for using delay profile as an artificial intelligence, AI, or machine learning, ML, model input, comprising:
processing circuitry configured to perform the method of claim 1; and
power supply circuitry configured to supply power to the processing circuitry.

38. A network node for using or providing delay profile as an artificial intelligence, AI, or machine learning, ML, model input, the network node comprising:
processing circuitry configured to perform the method of claim 23;
power supply circuitry configured to supply power to the processing circuitry.

39. (canceled)
